(19) United States
(12) Patent Application Publication
(10) Pub. No.: US 2004/0068479 A1
(43) Pub. Date: Apr. 8, 2004

(54) Exploiting asynchronous access to database operations

(75) Inventors: Charles Daniel Wolfson, Austin, TX (US); Constance Jane Nelin, Austin, TX (US)

Correspondence Address: SUGHRUE MION, PLLC, 2100 PENNSYLVANIA AVENUE, N.W., SUITE 800, WASHINGTON, DC, 20037, US

(73) Assignee: International Business Machines Corporation, Armonk, NY

(21) Appl. No.: 10/264,988

(22) Filed: Oct. 4, 2002

(51) Int. Cl. G06F 7/00

(52) U.S. Cl. 707/1

(57) ABSTRACT

Methods, apparatus and articles of manufacture are described that eliminate the administrative complexities, latency and scalability restrictions associated with conventional methods for providing asynchronous access to database operations. An asynchronous messaging engine is integrated with and executed within a database system and provides access to database system capabilities and resources, such as shared memory, buffer pools, and process controls. The need for external asynchronous message data exchange processes is eliminated, thereby eliminating the latency associated with the extra hop conventionally required to move data from an external process to the database and eliminating the complexities associated with starting, stopping and monitoring such processes. Because the asynchronous messaging engine executes within the database system and has access to database system capabilities, such as shared memory, buffer pools, and process controls, the new features allow support for an unlimited array of new asynchronous communications patterns between a database and asynchronous applications/clients.

### BACKGROUND OF THE INVENTION

1. Field of the Invention

The invention relates to database communications and processing. More particularly, it relates to improved methods, apparatus and articles of manufacture for implementing and exploiting asynchronous messaging in database operations.

2. Description of the Related Art

The real world is a mixture of synchronous and asynchronous activities. In some processing environments, it is necessary to wait to make sure that a task has been completed before another task is initiated (i.e., synchronous processing). In other processing environments, however, it is not necessary to wait (i.e., asynchronous processing).

To date, however, database programmers have been given only a synchronous world in which they make requests through a standard Application Program Interface (API) such as Java® Database Connectivity (JDBC), Object-Oriented Database Connectivity (ODBC), or Call-Level Interface (CLI) through which their application waits for a response. Some databases, such as Microsoft® Structured Query Language (SQL) Server, offer limited asynchronous capabilities via which a program can continue executing after the request is issued without waiting for a response. The Microsoft® SQL Server API provides for either polling or registered call-backs to be executed when the request has completed. While such features are a helpful convenience to the application developer, they do not leverage the capabilities provided by an asynchronous messaging system, such as International Business Machines' (IBM®'s) WebSphere® MQSeries® (MQ®), and asynchronous message brokering software, such as IBM®'s MQSeries® MQIntegrator® (MQSI), that supports the integration of asynchronous applications and processes in environments that use MQ® as the asynchronous messaging service.

FIG. 1 is a logical representation of conventional asynchronous message processing via the use of external data exchange processes executing outside of a database system, such as processes associated with an Extract Transform Load (ETL) system. As shown in FIG. 1, representative commercial applications 102, proprietary applications 104 and business partner applications 106 communicate, using an asynchronous messaging service 116, with a database server 114 running a database system 108 with an operational data store and access to data warehouses 110 that may reside on the database server 114, or be accessed remotely. Because the database system 108 has no integrated features for receiving and processing asynchronous messages, it must rely upon external data exchange processes running on the database server, to communicate with the asynchronous messaging service 116, and to extract, clean, transform aggregate and load the data into the database system 108.

Conventional methods and existing products that execute external to the database system, such as MQ® and MQSI, can be used to facilitate the exchange of data between asynchronous applications and database services. This can be achieved in several ways, however, all such external data exchange process based approaches suffer from inherent deficiencies. One representative approach uses MQ® or MQSI to forward messages from the MQ® message queues to the IBM® DB2® database, and vice versa, via an API such as ODBC. Using such an approach, asynchronous messaging connectivity and transactional protection is provided at the cost of an extra hop between MQ® and DB2®, and vice versa.

The approach, however, introduces administrative complexities, latency and scalability concerns. Administrative complexities arise because, using this approach, a process (i.e., MQ® and/or MQSI components) external to the database must be started and stopped in conjunction with the database. Additional latency is introduced with the extra hop required for the external data exchange process to wait for a message and write it to the database. To improve scalability, such an approach would need to batch the operation to read many messages and insert them into a database staging table in a single transaction, again at the cost of additional latency. Scalability using such an approach, however, is limited by the concurrent use of the staging tables by both the external data exchange process and the database system. This can be somewhat ameliorated by introducing different database tables for different queues, however, this is offset by the increased complexity in database operations and in administering the queues.

Based on these limitations, a strong need exists for methods and apparatus that more tightly integrate asynchronous message processing with database operations. The new apparatus and new methods should eliminate administrative complexities, latency and scalability restrictions associated with conventional methods for exchanging data between a database and an asynchronous message delivery service. The new methods and apparatus should reduce the complexities associated with external data exchange processes, such as the need to start and stop such processes externally to the database. The new methods and apparatus should reduce latency associated with the extra hop required to move data from an external data exchange process to the database and the need for database staging tables for efficiently execute the extra hop. The new methods and apparatus should improve scalability without increasing the complexity of database operations. The new methods and apparatus should support an unlimited array of new asynchronous communications patterns between a database and applications/clients, while assuring the integrity of data within the database.

### SUMMARY OF THE INVENTION

Therefore, in light of the above, and for other reasons that will become apparent when the invention is fully described, methods, apparatus and articles of manufacture are described here for more tightly integrating asynchronous message processing with database services and database data access, as well as techniques for exploiting asynchronous access to database operations.

The new features described here can eliminate the administrative complexities, latency and scalability limitations of the conventional methods for providing asynchronous access to database operations. In accordance with the newly described features, an asynchronous messaging engine executes as an internal process, or agent, within a database system and avails itself of database system capabilities, such as shared memory, buffer pools, and database process controls. The database, therefore, is able to directly monitor defined asynchronous messaging service connections, receive asynchronous messages directly from the asynchronous messaging service, and store the messages directly within the same in-memory and on-disk storage structures used by the database, thereby reducing both the amount of memory consumed and the speed with which the messages can be accessed by database operations.

These new features can eliminate the need for external asynchronous message data exchange processes, thereby eliminating the need to start and stop such external data exchange processes independently from the database. By eliminating external data exchange processes associated with asynchronous messaging communications, latency associated with the extra hop conventionally required to move data from an external data exchange process to the database is eliminated. Scalability is improved by eliminating the need for batch operations, database staging tables, and multiple tables per queue, thereby reducing the complexity of database operations. Because the asynchronous messaging engine executes as an agent within the database system and avails itself of database system capabilities, such as shared memory, buffer pools, and process controls, the new features allow support for an unlimited array of new asynchronous communications patterns between a database and applications/clients.

Features and advantages of the invention will become apparent upon consideration of the following descriptions and descriptive figures of specific embodiments thereof. While these descriptions go into specific details of the invention, it should be understood that variations may and do exist and would be apparent to those skilled in the art based on the descriptions herein.

### BRIEF DESCRIPTION OF THE DRAWINGS

FIG. 1 is a logical representation of conventional asynchronous message processing via the use of external data exchange processes executing outside of a database system.

FIG. 2 is a representative logical depiction of asynchronous messaging between a database and asynchronous applications and asynchronous clients, in accordance with the methods and techniques described here.

FIG. 3 is a representation of a physical networked computer wide-area-network/local-area-network (WAN/LAN) environment typical of that in which the methods and techniques described here are performed.

FIG. 4 is a representative system level block diagram of asynchronous messaging and database modules, in accordance with the methods and techniques described here, configured to efficiently integrate asynchronous message processing with database operations.

FIG. 5 is a representative process flow depicting the reception and processing of an asynchronous message by a database system, in accordance with the methods and techniques described here.

FIG. 6 is a ladder-logic representation of an exchange of asynchronous messages between an asynchronous client and an asynchronous database server resulting in the server initiating a side-effect, in accordance with the methods and techniques described here.

FIG. 7 is a ladder-logic representation of an exchange of asynchronous messages between a client and a database server in which the client disconnects after making a request and reconnects later to receive the response, in accordance with the methods and techniques described here.

FIG. 8 is a ladder-logic representation of an exchange of asynchronous messages between a client and a database server in which the client concurrently processes data received asynchronously from the server, in accordance with the methods and techniques described here.

FIG. 9 is a ladder-logic representation of an exchange of asynchronous messages between a first client and a database server in which the first client initiates an asynchronous request, and the database server returns an asynchronous response to a second client, in accordance with the methods and techniques described here.

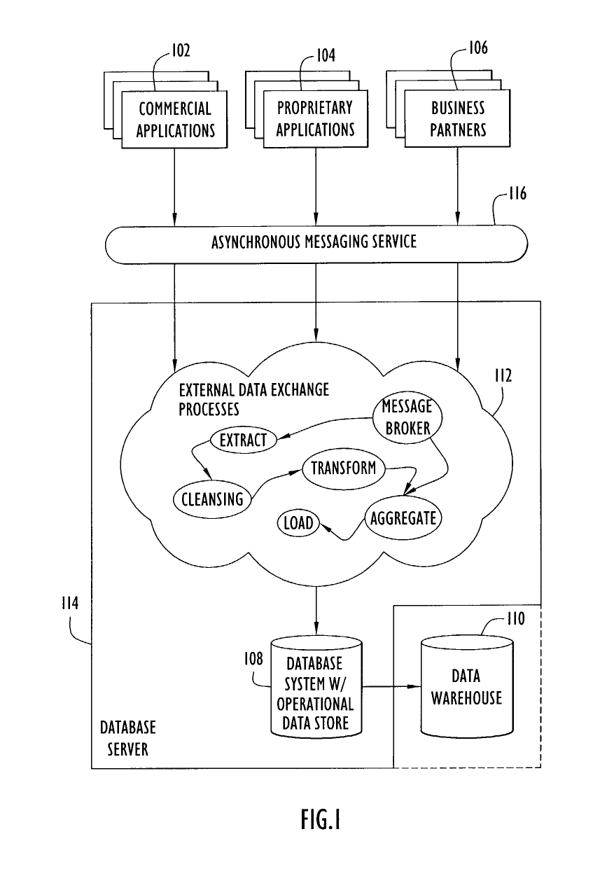

### DETAILED DESCRIPTION

The embodiments described below are described with reference to the above drawings, in which like reference numerals designate like components.

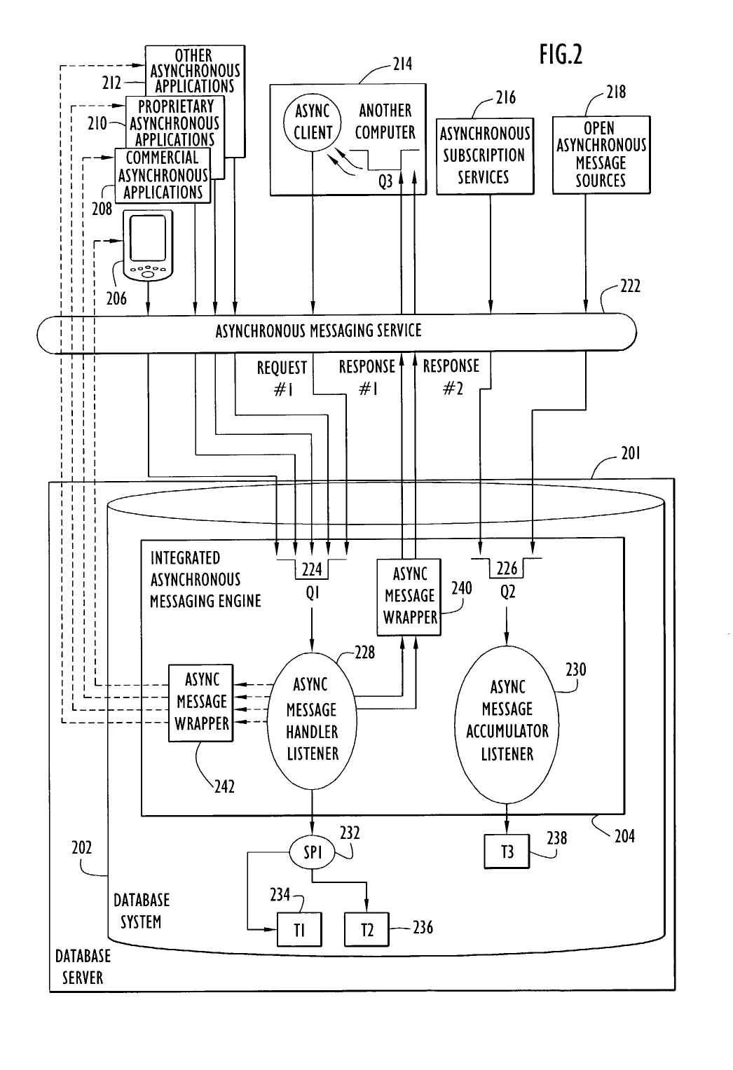

FIG. 2, is a non-limiting logical representation of a database server 201 executing an instance of a database system 202 with an integrated asynchronous data agent, or asynchronous messaging engine 204. The database system 202 communicates with a variety of asynchronous applications via an asynchronous messaging service 222. Examples of such asynchronous applications include personal digital assistants (PDA's) 206 executing asynchronous applications, commercial asynchronous application 208, proprietary asynchronous applications 210, other asynchronous applications 212, asynchronous clients 214, asynchronous subscription services 216, and open asynchronous message sources 218. An asynchronous message from an asynchronous application, such as one of the asynchronous applications described above, is transported by the asynchronous messaging service 222 to an endpoint defined upon the database server 201. An asynchronous message addressed to an endpoint associated with the database system 202 is received within an asynchronous message queue within the integrated asynchronous messaging engine 204.

As shown in FIG. 2, asynchronous messages received upon queue 226 (Q2) are extracted from the queue and processed by an asynchronous message accumulator listener 230 that stores the unaltered contents of the messages in a database table 238 (T3). Also shown in FIG. 2, asynchronous messages received upon queue 224 (Q1) are extracted from the queue and processed by an asynchronous message handler listener 228 that initiates a pre-defined action, such as a stored procedure 232. Such a pre-defined action can be any database supported capability, service, or database process, including but not limited to user-defined functions, triggers, database operations (e.g., insert, delete), process controls, administrative and utility services, etc. The stored procedure 232 processes the messages and stores message components in database table 234 (T1) and database table 236 (T2) and/or initiates appropriate database system capabilities which may or may not result in information being stored to a table.

Depending upon the nature of application with which a received message is associated, the asynchronous message handler listener 228, acting directly or through the stored procedure 232 can send an asynchronous message back to one or more asynchronous applications via an asynchronous message wrapper 240 or asynchronous wrapper 242. However, such a response is not required. The two asynchronous message wrappers (240 and 242) depicted in FIG. 2 are presented as separate entities for convenience purposes only. Depending upon the asynchronous protocols supported by the database system 202, different types of asynchronous message wrappers can be executed by the integrated asynchronous messaging engine 204 simultaneously. Alternatively, a single asynchronous message wrapper can be executed that supports the asynchronous protocol or protocols required.

As shown in FIG. 2, the asynchronous messaging engine 204 executes as an agent within the database system 202. By integrating the asynchronous messaging engine as an agent within the database system, the asynchronous messaging engine avails itself of database system capabilities, such as shared memory, buffer pools, and process controls. In one embodiment, the entire asynchronous messaging engine 204 executes in the same addressable/executable memory space reserved for execution of the database itself. In other embodiments, only select asynchronous messaging components, such as the asynchronous message handler listener 228 and/or the asynchronous message accumulator listener 230 execute in memory space reserved for database execution.

Through such tight integration of the database system 202 with asynchronous messaging capabilities, the database system is able to directly monitor defined asynchronous messaging service connections and store the messages directly within the same in-memory and on-disk storage structures used by other database system services, thereby reducing both the amount of memory consumed and the speed with which the messages can be accessed by database operations.

In one embodiment, as shown in FIG. 2, the database system receives asynchronous messages directly from the asynchronous messaging service 222 to message queues integrated within the database system. In other embodiments, the message queues are implemented external to the database system, but are directly monitored by asynchronous listeners integrated within the database system, as described above. In one embodiment that uses an external message queue and an integrated asynchronous message listener, the integrated asynchronous message listener is implemented to communicate with MQ®), and the external MQ® queue, as an MQ® client operating from within a DB2® database. In this manner, the integrated asynchronous message listener is able to directly monitor the external MQ® queue and extract received messages directly from the external MQ1 queue into the DB2® database. An increased efficiency associated with such an embodiment is that the integrated asynchronous message listener does not need to open a connection between MQ® and the DB2® database, as would an external asynchronous message data exchange process, for the integrated asynchronous message listener is operating from within the database itself.

Integrating the asynchronous messaging engine eliminates the need for external asynchronous message data exchange processes, thereby eliminating the need to start and stop such processes independently from the database. This is because components of the asynchronous messaging engine 204, such as the message queue, asynchronous message listener and asynchronous message wrapper are tightly integrated within the database and are started and stopped with the database itself. By eliminating external data exchange processes, latency associated with the extra hop conventionally required to move data from an external data exchange process to the database is eliminated. Scalability is improved by reducing the need for batch operations, database staging tables, and multiple tables per queue, thereby reducing the complexity of database operations. Because the asynchronous messaging engine 204 executes within the database 202 and avails itself of database system capabilities, such as shared memory, buffer pools, and process controls, the new methods and apparatus allow support for a vast array of new asynchronous communications patterns between a database and applications/clients. Furthermore, the resulting greater access to database services and new asynchronous communications patterns enables the database 202 to provide services previously unavailable, such as enabling a two-phase commit protocol for asynchronous database messages.

The database system depicted in FIG. 2 includes database tables and many different database services and capabilities. In one embodiment, the database system includes management programs for managing internal database processes. By integrating the asynchronous messaging engine and/or select asynchronous message listeners into the database as internal processes, or agents, executing under the control of the database system, such asynchronous messaging agents can be managed using the database system's management programs.

The database depicted in FIG. 2, can be configured to use a broad range of transport mechanisms and protocols to receive messages sent via a broad range of asynchronous messaging services to one or more endpoints defined within the database server upon which the database system executes. Messages received at each such endpoint are stored in a queue (i.e. table) within the database. Messages received by an asynchronous message queue can be structured in any format and each message is processed by an asynchronous listener, as previously described. Failures associated with the reception of a message within a queue or the processing a message by an internal, asynchronous listener, are logged and cause database transactions associated with the failed message to be rolled back. As depicted in FIG. 2, there are two types of asynchronous listeners: asynchronous message accumulator listeners 230; and asynchronous message handler listeners 228.

An asynchronous message accumulator listener 230 listens for messages on message queue 226 (Q2), extracts the messages from the queue and stores those messages automatically within a designated message table 238, defined within the database system. The asynchronous message accumulator listener can be configured to save all messages for a particular endpoint (e.g. for an audit trail) or to subscribe to a subset of messages (e.g. save only high value stock trades). The asynchronous message accumulator listener stores entire messages. It does not provide for selection, transformation, or mapping of message contents to database structures. Note that in the accumulator communications pattern, described above, a reply from the listener 230 to the message source is not required.

FIG. 2 shows the integrated asynchronous message accumulator listener 230 subscribing to messages from a publish/subscribe application 216 and other message sources 218. Messages that meet a subscription criteria are sent to Q2 226 by these message sources. The integrated asynchronous message accumulator listener 230 receives the messages sent to Q2 and inserts them into the table 238 (T3). This pattern may be useful for auditing of external events, to simplify tracing of application interactions and to facilitate recovery operations that use message replay techniques.

FIG. 2 further depicts an internal, asynchronous message handler listener 228 that listens for messages and invokes the appropriate handler, for example, a stored procedure, for the message endpoint. Any stored procedure can be invoked. This style of listener allows software developers to select, map, or reformat message contents for insertion into one or more database structures. Note that in this asynchronous message communications pattern, messages enter, but a reply is not required. The message handler can be a stored procedure with pre-defined inputs (message metadata and the message) and no outputs or result sets. It can perform processing to parse, process, manipulate and store information derived from the initiating message.

The asynchronous message handler listener 228 in FIG. 2 receives messages from message queue 224 (Q1). Messages are sent to Q1 directly by one or more applications. Upon receipt of a new message, the asynchronous message handler listener 228 extracts the message from the queue and invokes an appropriate stored procedure represented in FIG. 2 as a first stored procedure 232 (SP1). The stored procedure invoked by the message handler can initiate operations necessary to process the message to meet the operational needs of the application supported. In FIG. 2, such processing includes parsing the message into two different tables, a first table 234 (T1) and a second table 236 (T2) within the database.

A message handler processing pattern, as described above, is useful, for example, for populating active data warehouses. Such projects typically require information from a large number of sources to be propagated to a data warehouse. Message information is decomposed, reformatted, and inserted into the appropriate table structures using one or more stored procedures. This style allows developers to select, map, or reformat message contents for insertion into one or more database structures. Note that with respect to messages received from asynchronous applications, a reply is not required, however, such replies can be emitted, as indicated, in FIG. 2, by the use of both solid and dashed lines emitted from the asynchronous message handler listener 228. In one non-limiting, representative embodiment, the asynchronous message handler listener is a stored procedure with pre-defined inputs including message metadata (such as reply-to queue and correlation ID) and the message. The asynchronous message handler listener can perform processing to parse, process, manipulate and store information derived from the initiating message and may initiate other stored procedures to perform extended processing and/or to initiate synchronous or asynchronous communications with other processes.

As shown in FIG. 2, if a message handler needs to send an asynchronous message, the message handler passes the message content to an asynchronous message wrapper, either wrapper 240 or wrapper 242. The wrapper generates a properly structured and addressed asynchronous message and submits the formatted asynchronous message to the asynchronous messaging service for transmission. Although only two asynchronous message wrapper modules are depicted in FIG. 2., other such message wrapper modules can be used. Different variations of asynchronous message wrappers can be used to facilitate asynchronous communications via messaging services using different message formats and protocols.

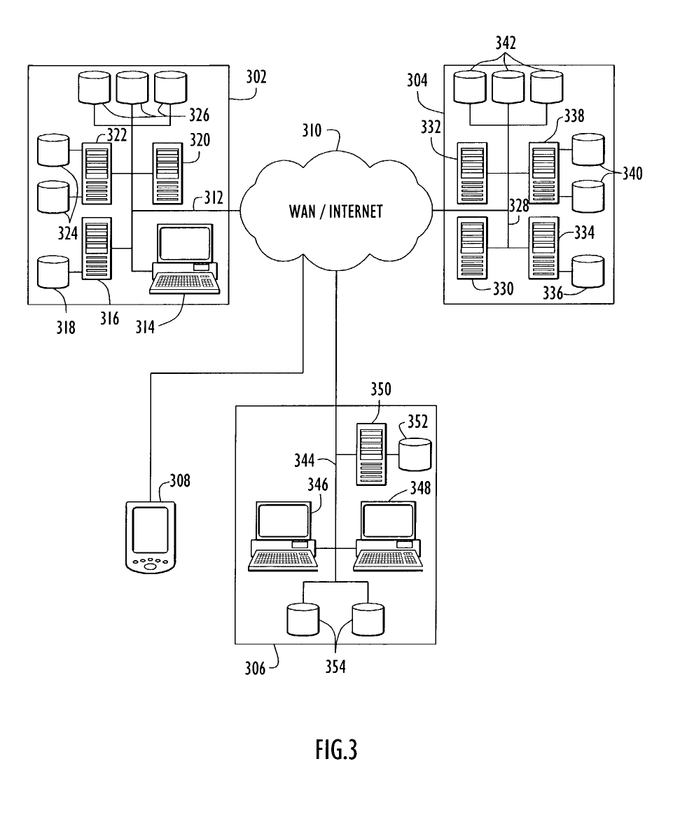

FIG. 3 is a representation of a computer wide-area-network/local-area-network (WAN/LAN) environment typical of that in which the new asynchronous messaging techniques described here are performed. FIG. 3 depicts a first local area network (LAN) 302 interconnected with a second LAN 304 and a third LAN 306 via a wide area network (WAN) 310. Asynchronous applications and processes executing on computers contained within each of the respective LANs are capable of communicating with applications and processes executing on computers in the other LANs and applications and processes executing on other devices, such as on a personal digital assistant 308, using asynchronous messages passed via an asynchronous messaging service, as previously described in relation to FIG. 2.

The first representative LAN 302 includes a local area network 312 that interconnects a workstation 312 with a first application server 316 with local data storage device 318, a second application server 320, and third application server 322 with local storage devices 324. Each of the three servers can execute one or more asynchronous and/or synchronous applications. Applications executing on the servers may use commonly shared LAN storage resourced 326 or the local storage dedicated to an individual server.

Likewise, the second representative LAN 304 includes a local area network 328 that interconnects a first application server 330, a second application server 332, a third application server 334 with local storage device 336 and a fourth application server 338 with local storage devices 340. Each of the four servers can execute one or more asynchronous and/or synchronous applications. Applications executing on the servers may use commonly shared LAN storage resourced 342 or the local storage dedicated to an individual server.

Similarly, the third representative LAN 306 includes a local area network 344 that interconnects a first computer workstation 346 and a second computer workstation 348, an application server 350 with local storage device 352. The computer workstations and server can execute one or more asynchronous and/or synchronous applications/clients. Applications executing on the servers and/or workstations can use commonly shared LAN storage resourced 354 or local storage.

The representative workstations and servers depicted in FIG. 3 are capable of supporting a database with integrated asynchronous messaging capability, as described in relation to the FIG. 2 at 202. Further, the representative workstations and servers depicted in FIG. 3 are capable of supporting one or more of the asynchronous clients, message sources, and other applications, as described in relation to FIG. 2. In addition, the representative LAN/WAN infrastructure depicted in FIG. 3, is capable of supporting an asynchronous messaging service or protocol, as described in relation to FIG. 2, that supports the transport of asynchronous application messages, using traditional or newly devised asynchronous message patterns, between the respective asynchronous applications and databases with integrated asynchronous messaging capability.

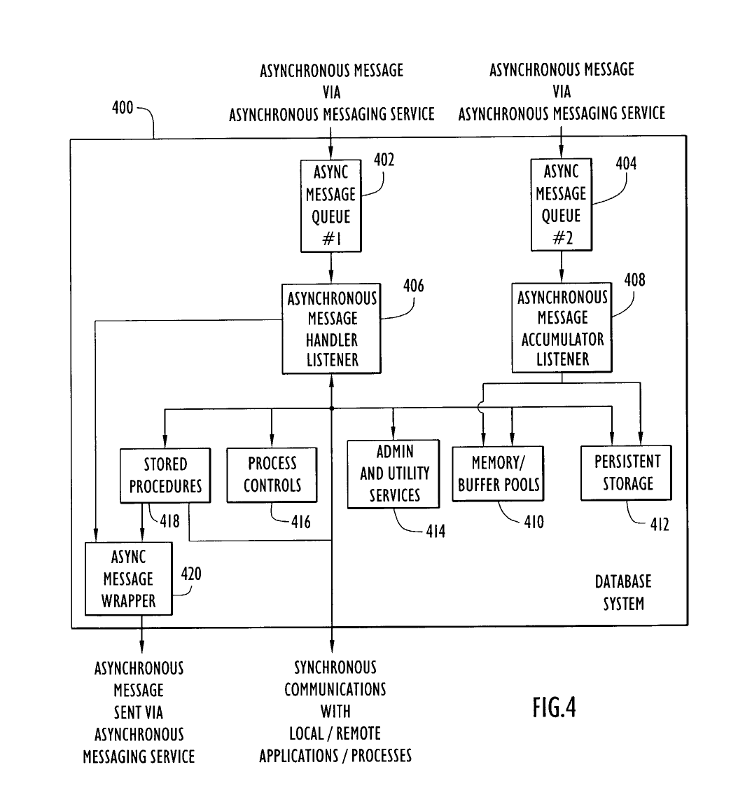

FIG. 4 is a representative, non-limiting system level block diagram depicting modules contained within a database system 400 with integrated asynchronous messaging capability. As depicted in FIG. 4, the database system 400 includes an asynchronous message queue 404 capable of receiving asynchronous messages via an asynchronous messaging service. The asynchronous message queue 404 is monitored by an asynchronous message accumulator listener 408 that detects that a message is received in message queue 404, and stores the message within database system memory/buffer pools 410 and database system persistent storage 412.

As further depicted in FIG. 4, the database system 400 includes an asynchronous message queue 402 capable of receiving asynchronous messages via an asynchronous messaging service. The asynchronous message queue 402 is monitored by an asynchronous message handler listener 406 that detects that a message is received in message queue 402, extracts the message from the queue and processes the message based upon the internal programming of the asynchronous message handler listener 406 and information contained within the asynchronous message received. In processing an asynchronous message, the asynchronous message handler listener 406 avails itself of database system capabilities and resources that can include database system memory/buffer pools 410, database system persistent storage 412, database system administrative and utility services 414, database system process controls 416, and database system stored procedures 418. The asynchronous message handler listener 406 can initiate synchronous communications with external/remote applications/processes either directly or via a stored procedure 418. Further, the asynchronous message handler listener 406 can initiate asynchronous communications using the asynchronous message wrapper 420 either directly or via a stored procedure 418.

As depicted in FIG. 4, message queues are monitored by asynchronous listeners. If the listener assigned to a queue is an asynchronous message accumulator listener 408 the message is stored, as received, directly within database memory/buffer pools 410 and/or database persistent storage tables 412 and processing is resumed at a later time by another database operation. If the listener assigned to a queue is an asynchronous message handler listener 406, the message is processed in accordance with the programming of the respective message handler. Such message handler programming can include a wide range of operations, including but not limited to: processing the received message and storing the manipulated information components stored within one or more database memory/buffer pools 410 and/or database persistent storage tables 412; initiating database administrative and utility services 414; initiating database processes 416 either within the same database server or on a remote database server; initiating a stored procedure 418 to performed significant processing and further handling of the message, such as initiating and monitoring secondary processes involving synchronous communications with other processes/applications; initiating an asynchronous message via an asynchronous message wrapper 420 either directly from the message handler 406 or via an initiated stored procedure 418.

In deciding whether to embed message handling logic in the asynchronous listener 406 or in a separately defined stored procedure 418, it is important to assess the nature of the processing required upon receipt of a specific message. For example, in some asynchronous message processing scenarios, such as data warehousing, there is a high rate of messages entering the system—but all of the messages are processed identically. If the logic to be executed is simple, then the overhead of invoking this logic as a stored procedure can be significant compared to the cost of executing the user logic. This leads to an approach that directly links user code within the listener, thereby bypassing a stored procedure invocation mechanism in favor of a shorter, but fixed code path.

If, however, the message rate is such that continuous processing of input messages is not the case, or when the logic to handle the message is complex, it makes more sense to implement the message handler as a specialized stored procedure. In such an environment the latency overhead to invoke a stored procedure to process an individual message is somewhat higher but not proportionally significant. In addition, such stored procedure handlers are simpler to develop, debug and alter providing a more flexible, reusable component that can be utilized on behalf of a broader range applications and queues.

FIG. 5 is a representative, non-limiting process flow depicting the reception and processing of an asynchronous message by a database system. As previously described, an asynchronous message queue that is integrated within the database system receives an asynchronous message via an asynchronous messaging service upon an asynchronous messaging service endpoint defined upon the database server 502. The message queue can be selected and/or configured to be compatible with any messaging service and/or protocol.

An asynchronous listener assigned to the message queue detects that a message has been received by the message queue and initiates a response 504. If the asynchronous listener is an asynchronous message accumulator listener 506, the asynchronous listener stores the message, as received, in the internal memory buffers and/or persistent storage tables of the database 508. If the asynchronous listener is a message handler 510, the asynchronous parses and/or processes the message in accordance with its internal programming 512. As previously described, such processing can encompass multiple operations that include, but are not limited to the following optional operations (shown by dashed lines). These optional processes can include storing components of the message within one or more memory/buffer pools and/or database tables in one or more databases 514; initiating and monitoring database administrative and/or utility services 516; initiating and monitoring secondary database processes either within the same database server or on a remote database server 518; initiating a stored procedure to perform complex processing and further handling of the message 520, such as initiating and monitoring secondary processes involving synchronous communications with other processes/applications 522; and initiating an asynchronous message via an asynchronous message wrapper either directly from the message handler or via an initiated stored procedure 524.

There are many benefits associated with asynchronous processing. One such benefit is that processing capability, that would otherwise be wasted while waiting for a task to complete or while waiting for a signal/response from another executing process, can be put to effective use processing another task. There are, however, additional benefits associated with asynchronous processing. These additional benefits stem from the breaking of the conventionally tight coupling between a requester and a service provider. In an asynchronous transaction/request between two parties, for example, it is not necessary to ensure that both parties are available before initiating the transaction/request. Furthermore, each party can process outstanding messages by making intelligent decisions about how and when to respond. These decisions can be based upon a process's internal workload and/or programmed priorities (i.e., based upon an internal assessment of the effective use of resources in meeting defined objectives). In addition, asynchrony (i.e., asynchronous processing) allows additional communications patterns to be developed beyond the conventional request/response. For example, because there is no rigid request/response protocol governing the processing of an asynchronous request, an asynchronous request can be routed from one service provider to another for processing. Thus the response to a request can come from a different provider than the provider to which the request was made. By way of a second example, a single asynchronous request can lead to the generation of multiple partial response messages, thereby allowing the requestor to process initial results before all results have been computed. The methods and apparatus described here, therefore, offer degrees of freedom that have not been generally enjoyed by database application developers.

For example, asynchronous message exchanges between a representative asynchronous client and one or more representative asynchronous database applications are not limited in any way with respect to processing order, intermediate/final destination, the number of intermediate/final responses generated and/or the recipients of the intermediate and final responses. Asynchronous message communication patterns can be one-way single messages or can comprise multiple messages where, for example, a single request message is processed resulting in an initial response followed by one or more subsequent response messages. The database decides the timing and order in which to process the requests. Priorities, and the request contents themselves, can be used by the database to determine how to schedule the execution of requests.

Web Services Description Language (WSDL) is used to describe the asynchronous messaging service and Simple Object Access Protocol (SOAP), or other WSDL compatible format, is used to describe the messages. Because each asynchronous message request initiated by either an asynchronous client, asynchronous application or asynchronous database is an atomic unit of work, no states are maintained between requests. All messages are eventually processed, but the order and timeliness of processing are not guaranteed

For example, in one non-limiting embodiment, an asynchronous client delegates, via message content in an asynchronous message sent to another application, the processing of a request to a different node than the node receiving the message. That is, the asynchronous message indicates that the receiving asynchronous listener forward the request to a second computer to complete processing. When the processing of the request is completed, a response is sent back to an endpoint specified in the original request, which may or may not be the originating asynchronous client.

An asynchronous listener responds to an architected message whether it comes from a supplied client or from another user application. This greatly expands the number of environments that can act as a database client. For example, rare client environments such as Macintosh®, Tandem®, or VAX® are readily supported since IBM®'s MQ® is directly available for use on those platforms and can couple those clients to the asynchronous messaging service. Clients not typically found in office environments, such as factory automation equipment, pervasive devices, or embedded controllers, similarly can communicate with DB2® either directly through MQ® or IBM®'s MQSI or through the many bridges and gateways that support MQ®. Furthermore, protocols such as HTTPR (i.e., HTTP with reliable delivery capability) and SOAP can be used to facilitate communications across an intranet or the Internet.

The client and database do not have to be available at the same time. In other words, if the client is only intermittently available, or happens to fail between the time the request is issued and the response is sent, the client will still receive the reply.

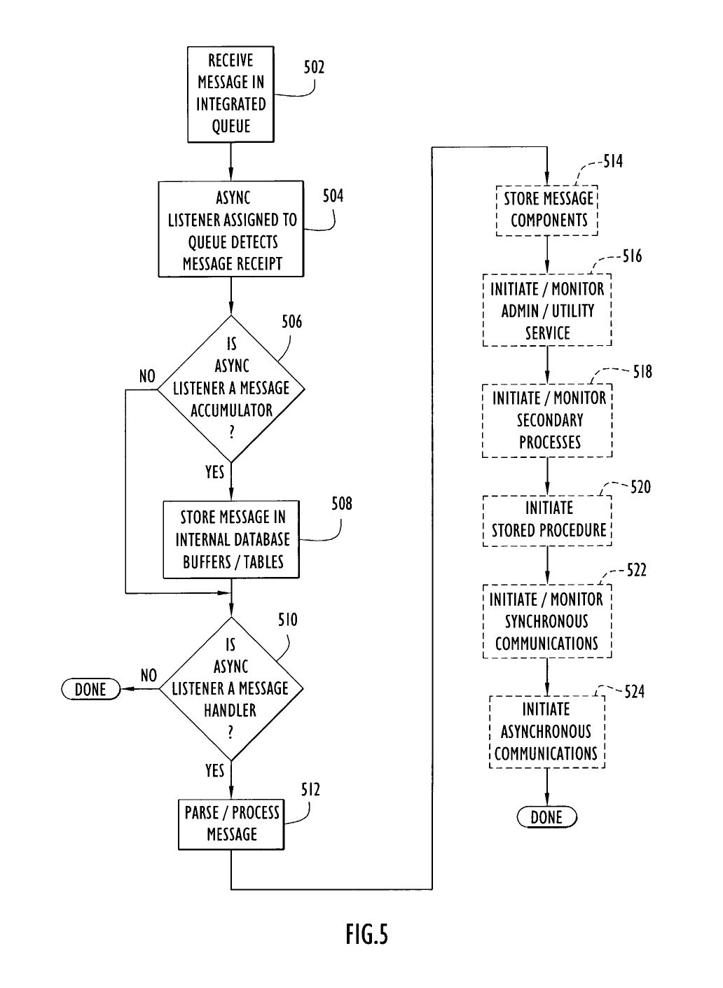

FIGS. 6 through 9, present representative communication patterns that can be accommodated by asynchronous applications that use a database with integrated asynchronous messaging capabilities to loosely couple operations performed by those independently executing asynchronous applications.

FIG. 6 presents a representative, non-limiting example of asynchronous messaging between an asynchronous client 600 and an asynchronous database server 602, in which a message 604, containing a request to be executed by the database server, sent from the client to the database server causes the database to initiate a desired side effect 606. The nature of the side effect depends upon the nature of the application executed. Depending upon the application requirements the acknowledgement message 608 depicted in FIG. 6, optionally, can be returned to the client. However, the client does not need to be informed of status concerning the request once it has been processed.

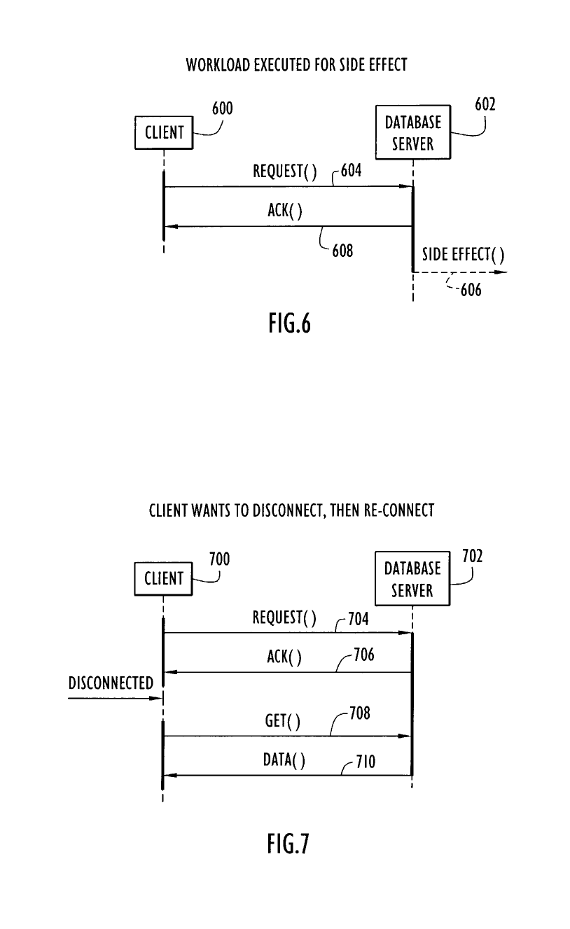

FIG. 7 presents a representative, non-limiting example of asynchronous messaging between an asynchronous client 700 and an asynchronous database server 702, in which the client sends a request 704 to the database server and then disconnects while request is being processed. The database server can return an acknowledgement 706, but the client does not require it. Later, the client reconnects to the database server to recover the generated results by sending a get message 708 to the database server. The database server then returns the results data 710. Such an asynchronous communications pattern can be used to improve availability by maximizing the availability of connection-related resources on the database server or to facilitate processing in environments where client connectivity is unreliable.

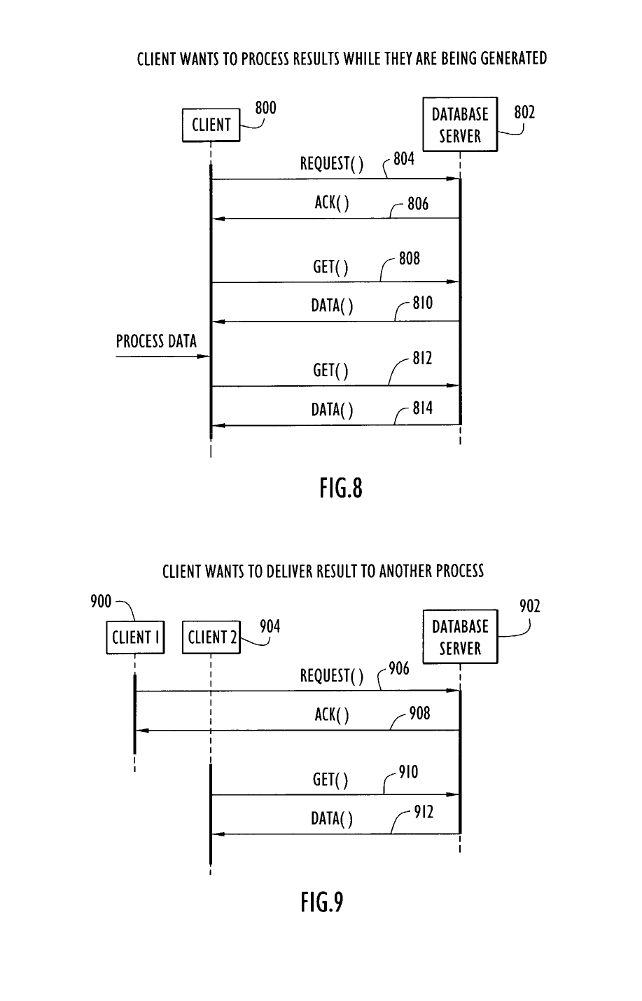

FIG. 8 presents a representative, non-limiting example of asynchronous messaging between an asynchronous client 800 and an asynchronous database server 802, in which the client wants to process early results while later results are being generated. First, the client sends a request 804 to the database server for processing. Optionally, the request 804 can contain a parameter that indicates the number of responses in which generated results are to be returned. The database server can return an acknowledgement 806, but the client does not require it. Later, the client sends a get message 808 to the database server, in response to which the database server returns a set of partial results data 810. The client continues to send subsequent requests 812 to which the database server responds with subsequent partial results data 814, until all results have been received. Using such a communications pattern, the client processes less data at once, thereby requiring fewer client resources. Furthermore, via such a communications pattern, the client is able to process data in parallel with server, thereby completing tasks sooner.

FIG. 9 presents a representative, non-limiting example of asynchronous messaging between asynchronous clients and an asynchronous database server in which a first client 900 submits a request 906 to a database server 902 in which the asynchronous message designates a second client 904 as the recipient of the processed results. The database server can return an acknowledgement 908, but the client does not require it. Later, the second client 904 sends a get message 910 to the database server, in response to which the database server returns a set of results data 912. Such a communications pattern adds significant flexibility with respect to the asynchronous processing participants, as well as with respect to temporal execution.

The examples presented above and described in relation to FIGS. 6-9 are representative of asynchronous communications patterns that can be implemented using the techniques described here. It will be understood that other patterns of asynchronous communications can be derived based upon combinations of the above patterns or other variations appropriate to meet the processing needs of a specific application. Many asynchronous patterns of communications can be developed using a database with integrated asynchronous messaging capability, as described, herein, regardless of whether the communicating participants include one or more additional databases with integrated asynchronous messaging capability, one or more asynchronous applications, and/or one or more asynchronous clients.

Asynchronous Message Request Content

Discussed below, are several representative, non-limiting examples of the content of asynchronous messages (e.g., requests) that are passed via the communications patterns described above with reference to FIGS. 6-9.

Event Handler Request

An event handler request is a one-way operation in which an architected message is used to describe the message contents and how the message contents are processed. For simple cases, this message contains the name of the table in which this message is inserted as text. In more complex cases the message specifies how to insert the message into a specified table. In one representative, non-limiting embodiment, the message contains the name of a handler to process the message. If an error occurs, the operation is rolled-back. Execution of the operation can be retried until a back-out retry count is exceeded, at which point the message is placed on a defined dead letter queue.

Asynchronous Stored Procedure Execution

A single stored procedure invocation request is sent to the database and a response is received. The request contains the input parameters and an indication specifying how many result sets are returned in the response message. The response message is addressed to an endpoint specified in the request and contains output parameters as well as the number of result sets in which the results are to be returned. One asynchronous response message per result set is generated, possibly using message groups. The stored procedure itself may, in fact, be comprised of separately executed operations performed within the database.

Stored procedure execution may also result in a chained style communication pattern where a first stored procedure is invoked and performs some work, then uses the asynchronous client to invoke a second stored procedure, indicating that the response is to be sent to the original requestor. The first stored procedure then sends back an initial response to the requestor with intermediate results. After the second stored procedure executes, it sends its result back to the initial requestor.

Query Execution

A single, architected database query statement is received and processed. The statement may contain any of a set of verbs, defined according to the query language used, such as SELECT, INSERT, UPDATE, or DELETE. The asynchronous response message(s) contain architected SQL results and are addressed to an endpoint specified in the request. For select statements, the request may specify that the response be chunked out across multiple asynchronous messages with each message being sent as soon as a chunk was complete. This allows the client to begin processing results before all the results have been generated. Extensible Markup Language (XML) operations can be supported with such architected messages.

Scriptlet Execution

A scriptlet is an atomic SQL program logic statement block that is interpreted and executed by the receiving database. Scriplets enable a variety of message patterns. The scriptlet is sent in a request and when executed, sends response messages containing partial results to the requester. When the scriptlet completes, a final message indicating success or failure is sent to the requestor. The entire scriptlet can execute as a single atomic transaction.

Normal Execution

The normal sequence of events performed by an asynchronous listener in processing asynchronous messages is to wait for a fixed duration to determine if a message has arrived. If no messages have arrived, the asynchronous listener checks whether a configuration change has been executed, and if so, the asynchronous listener reloads a configuration table structure. In one representative, non-limiting embodiment, configuration changes are sent out of band, perhaps through the internal queues provided by the database system. If no messages have arrived, the asynchronous listener continues to wait. When a message finally arrives, the message is processed according to a configuration table accessed by the asynchronous listener. Typically such processing involves calling an identified stored procedure, or processing the message in accordance with logic embedded in the listener, as previously described in relation to FIG. 2.

If message logging is enabled, a record of the message being received is sent to the indicated asynchronous log endpoint. If a stored procedures is called, the stored procedure is invoked and the resulting output message and status is sent to the logging endpoint, if enabled.

Startup and Configuration of Asynchronous Listeners (ASL)

The integrated asynchronous listener (ASL) is configured to read from one or more integrated asynchronous queues and for each queue either insert the contents of the queue into a table or invoke a stored procedure. Optionally, the result of the operation is logged. The integrated queue/ASL approach does not depend on the messaging protocol used, however, different types of listeners can be used, depending on the protocols to be supported (e.g., MQ®, SOAP, Jetstream Protocol, etc.).

Startup

At database startup, a configuration table is read into memory that describes information about one or more integrated database asynchronous listeners and integrated database asynchronous integrated queues. The configuration table contains the following information:

| | |
|---|---|
| Endpoint Type: | MQ ®, Asynchronous Messaging Interface (AMI), |
| | SOAP/Hypertext Transport Protocol(HTTP), |
| | JetStream, etc. |
| Endpoint address: | Registered local endpoint address for the type of |
| | listener protocol. |
| | For MQ ®, queue manager + queue name, |
| | For AMI servicepoint. |
| | For SOAP/HTTP, uniform resource locator(URL). |
| | For JetStream, IID. |
| Action: | Insert or Call |
| MaxMessageSize: | Max allowable message size in |
| | Bytes |
| User: | UserId under which action is to be taken |
| LoggedUsing: | Null if not logged. Valid mechanisms include |
| | Table, File, MQ ®, JetStream, etc. |
| LoggedTo: | Valid destination endpoint. |
| | Valid table name for table, file path |
| | for file, MQ ® queue for queue. |

For each endpoint, a separate thread (or process) is spawned. Each thread performs protocol specific initialization and listens for incoming requests at the endpoint. For example, to initiate an input under MQ® requires opening a connection to the MQ® queue manager.

Multithreaded Asynchronous Message Handler Listener

One representative, non-limiting embodiment of an asynchronous message handler listener is a multithreaded process executing within the database system that receives messages from an asynchronous message queue, calls a stored procedure, and sends error messages to a report log table if anything goes wrong.

The asynchronous message queue name, stored procedure name, report log table name and other required information for each thread is defined in a configuration file.

Stored Procedure Asynchronous Message Handler Listener

Another representative, non-limiting embodiment of an asynchronous message handler listener is an infinitely running DB2® stored procedure. The listener receives a message from an asynchronous message queue, performs a customer specified action, and sends an error message to a report log table if anything goes wrong. The customer specified action can be a set of SQL statements, for example, “insert into table values ( . . . )”, or it can be a routine that is provided by a customer.

Security Integration

Security integration depends on the type of client and the type of service provided. Asynchronous message listeners are configurable for both authenticated and unauthenticated requests. Asynchronous clients are authenticated, however, the specific mechanisms used to perform authentication are configured on an application specific basis.

Having described methods and apparatus for exploiting asynchronous access to database operations, it is believed that other modifications, variations and changes will be suggested to those skilled in the art in view of the teachings set forth herein. It is therefore to be understood that all such variations, modifications and changes are believed to fall within the scope of the present invention as defined by the appended claims. Although specific terms are employed herein, they are used in their ordinary and accustomed manner only, unless expressly defined differently herein, and not for purposes of limitation.

### Trademarks

IBM®, WebSphere®, MQ®, MQSeries®, MQSeries® MQIntegrator®, and DB2® are trademarks or registered trademarks of International Business Machines, Corporation in the United States and other countries. Java® is a trademark or registered trademark of Sun Microsystems, Inc., in the United States and other countries. Microsoft® is a trademark or registered trademark of Microsoft® Corporation, in the United States and other countries. Macintosh® is a trademark or registered trademark of Apple Computer, Inc., in the United States and other countries. Tandem® is a trademark or registered trademark of Tandem® Computer's Incorporated, in the United States and other countries. VAX® is a trademark or registered trademark of Digital Equipment Corporation, in the United States and other countries.

What is claimed is:

1. An asynchronous data agent for use within a database having a plurality of tables, comprising:
an asynchronous message listener integrated within the database, and coupled to a message queue suitable for receiving a message from a message source, configured to process the message from the message queue and to interact with the database based on the message.

2. The asynchronous data agent of claim 1, further comprising said message queue, wherein said message queue is integrated within the database.

3. The asynchronous data agent of claim 1, further comprising a configuration file, wherein the configuration file defines how the asynchronous message listener processes the message.

4. The asynchronous data agent of claim 1, wherein the asynchronous message listener automatically stores information within at least one of the database tables based upon information within the processed message.

5. The asynchronous data agent of claim 1, wherein the asynchronous message listener accumulates received messages within at least one of the database tables.

6. The asynchronous data agent of claim 1, wherein the database further comprises a plurality of processes and wherein the database processes execute in a database memory space and wherein the asynchronous data listener executes within the database memory space.

7. The asynchronous data agent of claim 1, wherein the asynchronous data listener executes as an agent within database.

8. The asynchronous data agent of claim 1, further comprising a stored procedure initiated by the asynchronous message listener in response to processing the message.

9. The asynchronous data agent of claim 1, wherein the asynchronous message listener is started automatically in response to starting the database.

10. The asynchronous data agent of claim 1, wherein the asynchronous message listener processes the message by placing the message directly in one of the database tables.

11. The asynchronous data agent of claim 1, wherein the database includes a shared memory resource for shared use by the database and the asynchronous data agent.

12. The asynchronous data agent of claim 1, wherein the asynchronous message listener includes user specified program code configured to process the message in an asynchronous manner.

13. A method of providing asynchronous access to a database having a plurality of tables, comprising:
processing a message in an asynchronous manner using an asynchronous message listener integrated within the database, configured to process the message and to interact with the database based on the message.

14. The method of claim 20, further comprising:
the asynchronous message listener monitoring an asynchronous message queue; and
the asynchronous message listener extracting the message from the queue in response to detecting that the message has been received.

15. The method of claim 21, wherein the asynchronous message queue is executed from within the database as a database agent.

16. The method of claim 20, wherein the processing includes the asynchronous message listener storing information within at least one of the database tables based upon information from the processed message.

17. The method of claim 20, wherein the asynchronous message listener accumulates received messages within at least one of the database tables.

18. The method of claim 20, wherein the database further comprises a plurality of processes and wherein the database processes execute in a database memory space and wherein the asynchronous message listener executes within the database memory space.

19. The method of claim 20, wherein the asynchronous message listener executes as an agent within the database.

20. The method of claim 21, wherein the asynchronous message listener initiates a stored procedure to process the message in response to extracting the message from the queue.

21. The method of claim 20, further comprising starting the asynchronous message listener automatically in response to starting the database.

22. The method of claim 20, wherein the asynchronous message listener processes the message by placing the message directly in one of the database tables.

23. The method of claim 20, wherein a shared memory resource is used by the database and the asynchronous message listener.

24. The method of claim 20, wherein the message has a message source and the asynchronous message listener returns to a destination other than the message source at least one message containing results of processing the message.

25. The method of claim 20, wherein the asynchronous message processes the message in an asynchronous manner using user specified program code.

26. The method of claim 20, wherein the message has a message source and the message source is an asynchronous client that sends the message via an asynchronous messaging service, and wherein the message contains a request to the asynchronous message listener for processing.

27. The method of claim 39, wherein the asynchronous message listener continues to process the extracted message when the asynchronous client is disconnected from the asynchronous messaging service.

28. The method of claim 40, wherein the asynchronous message listener, upon determining that the asynchronous client is reconnected to the asynchronous messaging service, sends a response to the asynchronous client containing a portion of the results generated in response to receiving the message submitted by the asynchronous client.

29. The method of claim 39, wherein the request at least one of:
describes the asynchronous message;
instructs the asynchronous message listener on how to process the asynchronous message;
specifies the number of response messages in which request results are to be returned;
instructs the asynchronous message listener on how to process the asynchronous message via instructions written in Structured Query Language;
instructs the asynchronous message listener on how to process the asynchronous message via instructions written in Extensible Markup Language;
instructs the asynchronous message listener on how to process the asynchronous message via a scriptlet;
instructs the asynchronous message listener on how to process the asynchronous message via an Structured Query Language program logic statement;
identifies at least one of a process, application, or resource to be used in servicing the request; and
identifies at least one of a process and application to which generated results are to be returned.

30. A computer readable medium of instructions suitable for execution on a computer for providing asynchronous access to a database having a plurality of tables, comprising:
program instructions for processing a message in an asynchronous manner using an asynchronous message listener integrated within the database, configured to process the message and to interact with the database based upon the message.

31. The computer program of claim 55, further comprising program instructions for starting the asynchronous message listener automatically in response to starting the database.
